(19) United States
(12) Patent Application Publication
(10) Pub. No.: US 2019/0122175 A1
(43) Pub. Date: Apr. 25, 2019

(54) Method and system for managing a fleet of galley containers

(71) Applicant: Zodiac Aircatering Equipment Europe B.V., ALKMAAR (NL)

(72) Inventors: Ronald VERWEIJ, AMERSFOORT (NL); Sergio Luis GOMEZ SERRANO, HAARLEM (NL)

(73) Assignee: Zodiac Aircatering Equipment Europe B.V., ALKMAAR (NL)

(21) Appl. No.: 16/091,121

(22) PCT Filed: Apr. 4, 2017
(86) PCT No.: PCT/NL2017/050212

§ 371 Date: Oct. 4, 2018

(30) Foreign Application Priority Data
Apr. 4, 2016 (NL) 2016545

(51) Int. Cl. G06Q 10/08

(52) U.S. Cl. CPC G06Q 10/0838; G06Q 10/087

(57) ABSTRACT

The invention relates to a management system for managing at least one galley container fleet comprising at least one galley container, the system comprising a server comprising a processor and a memory unit, wherein the processor is connected to the memory unit and wherein a computer program for operating the managing system is loaded onto the memory unit; at least one galley container; a galley container identifier module comprising galley container identifier data, wherein the server is arranged to receive first input data comprising the galley container identifier data, and to render at least part of the container profile in response to said input data; and at least one user interface device. The invention further more relates to a method for operating a galley container fleet management system by using a server.

### TECHNICAL FIELD

The invention relates to a system for managing a fleet of galley containers, to a method of operating a galley container fleet management system, and to a galley container for use with the method and system according to the invention. Furthermore, the invention relates to a computer program arranged to perform such a method, and a computer readable medium comprising such a computer program.

### BACKGROUND ART

The transport of passengers or goods often entails the provision of services aboard the transport vehicle, such as meal service for passengers and/or the crew, and the sale of merchandise. To this end, it is common for transport vehicles hosting these services to be fitted with a specialized compartment which may be referred to as a galley. A galley provides a space for holding (removable) containers, and may provide a mechanism for locking the container in place. The containers are loaded with the necessary items and subsequently transferred to the transport vehicle prior to the start of the transport service. It is frequently the case that the entity preparing the containers for the service is different from the entity hosting the service. The division of the tasks associated with preparing and handling the containers complicate the process logistics and render it vulnerable to, for example, errors arising from miscommunications between the various parties.

Further, the containers are exposed to security breaches, particularly when the containers include valuable items such as luxury goods for duty-free sale aboard international flights. Presently, container handling mechanisms are rather vulnerable in this aspect, resulting in a high incidence of merchandise theft and container loss. Thus, there is a need for systems and methods which maintain the contents of the container properly secured across the process.

Moreover, containers are frequently rendered defective prematurely due to a lack of strategic container usage in the methods and systems currently used. A typical container use-cycle for a service begins with the random retrieval of the container from a storage facility storing a plurality of containers. Usually, the containers within easier reach (for example, near the front of the storage facility) will be selected first, while containers that are stored in areas that are more difficult to reach are selected less frequently. After the service, the containers are stored again in the storage facility, and most likely will be again stored in the most easily reachable space in the storage facility. Thus, these same containers are more likely to be selected for the next service. The result is that some containers may be used excessively while other containers may never be selected for use. This leads to a lack of uniformity in the wear and tear of the container fleet, and to a premature end of the lifecycle of containers which are used more frequently.

Further, containers for a catering service may include perishable items such as food and beverages for a meal service onboard a passenger airplane. Such containers may have to be kept under a minimum temperature at all times after loading pursuant to health regulations. In order to comply with this requirement, the current process involves many checks by operators throughout the preparation and loading process. These checks are time-consuming.

Thus, current systems and methods of preparing and handling containers fleets are cumbersome and frequently result in the loss of containers, loss of contents, and incomplete or incorrect deliveries.

Therefore, it would be desirable to provide a manner which facilitates the handling, preparation and transfer of containers and minimizes errors throughout the process.

### SUMMARY OF INVENTION

According to the invention, there is provided a method for operating a galley container fleet management system by using a server, the fleet comprising one or more galley containers, the server comprising a processor and a memory unit, wherein the processor is connected to the memory unit and wherein the processor is configured to execute the following steps:

registering at least one galley container of the fleet in a database stored in the memory unit, wherein the step of registering the at least one container comprises associating the galley container to the galley container fleet and generating a galley container profile for associating galley container parameter data, the galley container profile comprising galley container identifier data;

receiving first input data from a first user interface device, the first input data comprising at least the galley container identifier data; and

rendering first output data to a second user interface device in response to the first input data; or

updating the galley container profile in response to the first input data if the first input data comprises galley container parameter data.

The term “server” refers herein to any type of server implementation such as cloud-based server, or a physical server.

The term “galley” refers herein to any area on a transport vehicle which is dedicated to the holding or placement of transport servicing elements, including containers, in particular to an onboard kitchen.

The terms “container” or “galley container” refer herein to containers with wheels (e.g., trolleys), containers without wheels, containers adapted for storing perishable items, containers for non-perishable items, high-security containers, and any other type of container which may be loaded onto a transport vehicle galley. The containers may be movable containers. This is advantageous as it allows for easier transport and movement of the galley container. Preferably, the catering container is a trolley on board of a passenger transport vehicle such as an airplane. This facilitates the management of a fleet of airplane galley trolleys. The container includes an identifier module which includes container identifier data.

The term “(galley container) parameter data” refers herein to any type of qualitative or quantitative data, which is related to the galley container.

The term ‘input data’ refers herein to any data received by the server, and may include and is not limited to a request, command, instructions or substantive data such as parameter data.

The term ‘output data’ refers herein to any data transmitted by server to an external entity, it includes messages, instructions, or substantive data.

A user, for example a catering service operator or an airline operator, wishing to facilitate the management of a fleet of containers may register one or more containers in the system. Registration of a container may be initiated by the user with a user interface device (UID), which provides an interface for the user to communicate with the server. The user employs the UID to provide identifying data about each container to be registered. For example, the UID may be configured to retrieve container identifier data from the container identifier module. For example, the container identifier module may comprise an RFID tag, and the UID may comprise RFID tag reader means. Alternatively, the user may manually enter container identifier data into the UID, for example, via a keyboard or touchscreen or other such input means.

Registration results in the creation of a container profile in a database of the server, and preferably the registration also results in associating the container with a particular fleet. A fleet may comprise all of the containers handled by the user. Additionally or alternatively, the container may be associated with a galley fleet, that is, a temporary fleet comprising a set of containers assigned to the same service or galley. Once a container is registered in the system, its container profile may remain in the server for subsequent use.

Once a container profile is created, it may be used to associate the container with data related to the container. The data may be acquired via a sensor module. Preferably, the container comprises a sensor module for sensing data related to the trolley. More preferably, the sensor module comprises a memory unit for storing sensed data. The sensor module may comprise any number of sensing components, which may be arranged separately and in different areas of the container. The various sensing components need not be provided integrally. The sensor module advantageously facilitates the collection of reliable data related to the container. For example, the sensor module may comprise a temperature sensor for automatically sensing and recording temperature data, and/or a door sensor for sensing and recording data on door events, i.e. opening and/or closing of the door. This data is forwarded to the server wherein the container has been registered, and the data is associated with the container profile.

The server associates the data received from the sensor module with the container profile. An operator wishing to check whether the contents of a galley container has been kept within a permissible temperature range may access the temperature data as indicated in the container profile remotely via a user interface device.

Thus, the method allows a user to configure and operate a centralized fleet management system, thereby enabling the user to easily and conveniently track any number of galley containers of a fleet throughout their use-cycle and/or lifecycle. The method further enables multiple users to have an overview of a fleet of galley containers.

The UID may be used to perform a variety of tasks, both in order to update the container and/or fleet profiles, and to view or render the container and/or fleet profiles or parts thereof. For example, the UID can be used to retrieve parameter data from the container sensor module, to transfer parameter data from the sensor module to the fleet management system (as input data to the server), or to remotely retrieve a galley container profile, fleet profile, galley fleet profile, or a part thereof from the server. In this manner, the centralized fleet management system can be kept up to date and information such as the conditions and status of the galley containers be known and accessible to system users with a UID, regardless of their location. The UID may communicate with the container via, e.g., RF, Bluetooth, or any other suitable communication means.

Updating of the galley container and/or fleet profiles may be effected in several ways. Updating may at least comprise comparing the galley container profile with the first input data for determining whether and update of the galley container profile is required. The comparison is done to check whether an update of the galley container profile is required. When it is determined that an update is required, the method may further comprise at least one of adding galley container parameter data from the first input data to the galley container profile, and replacing galley container parameter data in the galley container profile with galley container parameter data from the first input data. In checking whether an update is necessary, the server may compare the input data with data in the galley container profile. Thus, when receiving input data, the server may check whether an update to the galley container profile is actually necessary, and may decide not to update the galley container profile. This step can advantageously save system resources by preventing unnecessary updates. It may be desirable to replace part or all of the data in a galley container profile when the container is being prepared for a new service cycle, as past data related to certain parameters may be considered irrelevant.

In order to provide a useful overview of the conditions of the galley container, the galley container profile parameter data may comprise content data, security data, custodial data, location data, temperature data, condition data and/or operational status of the galley container. Each of these types of data may be advantageous to the users. The content data may relate to, for example, a stock list of items loaded into the container. Content data may be automatically or manually entered. For example, the UID may show a list that the user must check off in order to indicate that the listed contents have been loaded. Any items checked would form part of the content data. The security data may comprise data related to container door locking and unlocking events. The sensor module may comprise a door sensor for sensing or detecting such door locking and door unlocking events. The door sensor may additionally comprise means for identify a user associated with the door locking/unlocking event and the security data may additionally comprise data identifying the time and entity/operator locking and/or unlocking the container. The security data may additionally comprise data related to a duration of an unlocking event. The system may be configured to issue an alert or warning upon detecting a security breach. Keeping record of such door-related events may aid in deterring theft of items stored in the container. More preferably, the door sensor data may additionally include data identifying the user associated with each door event. The location data may comprise geographical data or more generalized location information such as an indication that the container is ‘in flight’ or ‘in storage facility’. This allows a user to easily locate a container. The custodial data may comprise data related to the entity handling the container at a particular point in time, such as ‘airline crew’ or ‘catering operator’. This allow a user to check whether, for example, a container has been transferred from a catering operator to an airline crew member. The condition data may comprise data about, for example, repairs or battery replacement needed in relation to the container and/or it may comprise data related to the frequency of use of the container and/or may comprise statistical data about usage of the container. This allows a user selecting containers for use in a service to rotate use of the containers in an advantageous manner so as to prevent overuse and/or underuse of a container. This further provides greater predictability and uniformity in relation to maintenance and repairs of the containers. The temperature data enables a user to check temperature history of the container and confirm whether handling of the container is in compliance with health regulations. The operational status parameter may comprise data related to the current service status of the container, for example, it may indicate that the container is currently in use, and may comprise data related to whether the galley container is in use, or the date when the container was last used, and/or may comprise statistical data about usage of the container. Therefore, a container profile advantageously provides a thorough and practical overview of a container. Further, all the parameters may be determined or sensed at regular time intervals so that a parameter history may also be stored and generated upon request. All parameter data discussed herein may comprise a data point at a particular point in time, a data history comprising multiple data points spanning a specific time period, event, or cycle, or an average, mean or other statistical representation of the sensed/measured data. The sensor module may be configured accordingly.

Containers which are to be prepared for meal services may need to be kept under specific temperature conditions in order to comply with health regulations. Thus, the sensor module of such containers may include means for sensing a temperature associated with the container. The sensed temperature could be, for example, an internal container temperature or an external container temperature. The temperature may be sensed continuously or at predefined time intervals. Additionally, the sensor module may include processing means configured to issue a warning when the temperature has exceeded a threshold. For example, an alert may be issued when the temperature has exceeded a predefined minimum, or when the temperature is close to exceeding a predefined minimum. Alternatively, an alert may be issued when the temperature has dropped below a predefined maximum temperature or when it is close to dropping to below a predefined maximum temperature. Alternatively, the sensor module may be configured to send the temperature data to external processing means which is configured for providing such alerts.

This wide range of possible parameters to be sensed, tracked, and stored enables the server to maintain detailed and useful information about the container in the container profile. This is advantageous to the user of the fleet management system since the user need only access the container profile in order to obtain detailed current and historical information about the container.

According to a further embodiment, the output data related to a galley container comprises the galley container profile or a part of the galley container profile. Thus, a user who is remotely located with respect to the container may, for example, use a second user interface device to retrieve and view part of the profile of the container from the server. The user may only be able to access part of a profile to the access level assigned to the user. For example, a user having a ‘full access level may have access to all the information related to a container and/or fleet, while a user having a ‘partial access level’ may only have access to part of the container profile and/or fleet profile. This adds flexibility to the system and enables it to serve a plurality of users of the fleet management system, which users may have varying levels of access authority to the galley container information.

In an embodiment, specific access or authority levels for effecting any of the steps or functions of the method and system may be assigned to an entity. Thus, when the first input data comprises a query from a querying entity, the method may further comprise the step of rejecting or granting the query based on the galley container profile prior to rendering output data relating to the galley container, the rejection or grant of the query being based on an access level of the querying entity. This enables the server to distinguish between querying entities or users based on their particular access level and to make a decision whether to render data in response to a query depending on the querying entity access level. This advantageously allows the fleet management system to securely serve different entities while collecting, storing and processing data in a centralized manner.

According to an embodiment, receiving input data and rendering output data via a wireless network and/or a wired internet connection. This enables convenient communication channels between the server and one or more user interface devices, and to adjust to different infrastructure scenarios. For example, in-flight updates may be possible via a wireless network when flying over highly infrastructured areas. However, such updates may not be possible when flying over low infrastructured areas, and any updates may have to be effected upon landing, when wireless network or a wired network becomes available for use by the system.

According to a further embodiment, the first user interface device and the second user interface device may be the same device. This advantageously allows a user to send input data to the server and receive output data from the server with a single device. For example, a user, having just sent a command to update a particular container profile, may subsequently request to view that container profile in order to confirm that the container profile has been updated.

According to a further embodiment, the method further comprises the step of registering at least one galley container fleet in the database, said step comprising generating a galley container fleet profile for associating data or metadata related to the containers with the fleet. This allows the user to register any number of fleets in the fleet management system and enables the association of galley containers with a registered fleet. Further, this enables centralized gathering of container data and facilitates the generation of useful metadata related to the containers and the fleet. Alternatively or additionally, a user may register galley fleets, that is, fleets comprising a set of containers for use in a particular service.

According to another embodiment, the method comprises the step of associating the galley container fleet profile with a data generating program loaded on the server. This enables the user to associate each fleet with predefined programs comprising instructions for producing metadata about the fleet and/or containers. The data generating program may comprise, for example, instructions for generating statistical data related to the containers in the fleet.

According to an aspect of the invention, the input data further comprises a command, wherein the method further comprises the step of executing the command after receiving the first input data from a first user interface device.

A command is distinguished from regular input data in that it comprises instructions causing the server or the UID to execute an action. Further, a command as used herein is distinguished from the instructions preloaded in the server, as the command originates in the UID. A command may comprise, for example, an update command to cause the server to update of the galley container profile, or may comprise specific requests for data or metadata to be rendered to the UID. This advantageously allows a user to request data as needed, for example, allowing a user to remotely check a container status, thus enhancing the utility of the fleet management system.

According to a further embodiment, the method further comprises the step of generating an entity profile and/or user profile in the database. This enables the server to distinguish between different users of the system. Further, the method may additionally comprise the step of assigning an access/authority level to the entity and/user profile. This enables the server to determine whether a particular entity or user requesting data or issuing other commands has the appropriate access or authority level to receive the data. As used herein, entity refers to a general category of users, for example, users associated with an airline crew, while the term user refers to a specific individual, who may or may not be associated with an entity.

The invention is also related to a computer program is provided comprising instructions that, when loaded onto a memory unit of a server, allow a processor of the server to execute the methods described herein. This advantageously enables configuration of any suitable server in order to execute the method according to the invention.

Moreover, the invention is related to a management system for managing at least one galley container fleet comprising at least one galley container is provided, the system comprising:

a server comprising a processor and a memory unit, wherein the processor is connected to the memory unit and wherein a computer program as described above is loaded onto the memory unit, whereby the server is configured to perform the steps of any of the methods described herein above;

at least one galley container, wherein the galley container comprises an identifier module comprising galley container identifier data; and

one or more user interface devices.

The container identifier module may comprise any suitable passive or active device such as a transceiver (for example, a passive or active RFID tag) a barcode label, a magnetic stripe, any Bluetooth readable device, or any other suitable passive or active means.

The sensor module can be configured so that it sends the data together with identifying data. Further, the sensor module may comprise a transponder which transmits sensed data upon interrogation.

According to another embodiment, the at least one galley container of the system comprises at least one galley container parameter sensor module, the sensor module being configured to sense galley container parameter data, and comprising a memory unit to store sensed parameter data. This advantageously enables the sensing and storage of galley container parameter data, which may then be retrieved via the UID in order to the transmitted to the server. Alternatively the sensed data may be directly transmitted to the server. This enables the server to update the container profile according to the sensed data.

According to a further embodiment, the galley container is provided with communication means in data connection with the parameter sensor module, wherein the communication means is configured to transmit sensed parameters of the galley container from the sensor module to a user interface device and/or to the server. The container may alternatively or additionally comprise a transponder which transmits sensed data upon interrogation. This enables to retrieve sensed data from the sensor module via a communication link.

In an embodiment, the one or more user interface devices comprise portable or handheld devices. This allows a user to easily and conveniently transport and handle the UID in order that the UID may interact with the container identifier module or sensor module.

In addition, the invention relates to a galley container for use in the method and/or for use with the system as described above. The galley container may comprise a parameter sensor module configured to sense and store data related to one or more parameters of the galley container. The sensor module may comprise any number of sensing components and may be integrally provided with the container or may be retrofitted into a container.

The one or more parameters may comprise one or more of a content parameter, a security parameter, an operational status parameter, a temperature parameter, location parameter, a condition parameter, and a custodial parameter.

This advantageous a centralized collection and tracking of data related to the galley container for aiding in management of the fleet.

Moreover, the invention relates to a method of use of the management system described above is provided, comprising:

identifying at least one galley container of a fleet using the galley container identifier module;

with a first user interface device sending first input data comprising at least the galley container identifier data, to the server, wherein the first input data is compared with a galley container profile;

receiving first output data on a second user interface device in response to the first input data.

According to a further aspect, the first input data comprises galley container parameter data, comprising one or more of galley container contents data, galley container security data, a galley container location data, a galley container location history, a galley container temperature data, condition data, and/or an operational status data of the galley container. Thus, the user may effect an update of the container profile by sending data related to any of these parameters via the UID to the server. These data may be entered manually into the system. Alternatively, or in addition, the parameter data may be entered and/or obtained via a sensor module in the galley container itself. Such a module may communicate with both or either of the UID and/or server.

According to another aspect of the invention, the input data comprises access level data, wherein sending the input data comprises sending a query to the server and wherein receiving first output data comprises a rejection or a grant of the query based on the access level data. This allows the server receiving the input data to distinguish a user based on their access level and to respond to a query in accordance with the user's access level. The access level can refer to the kind or amount of input data that can be uploaded by the user. It can also relate to the kind or amount of output data that can be received by the user.

According to a further aspect of the invention, the output data related to the galley container comprises galley container data, security data, galley container location data, galley container geographical location data, galley container temperature data, and/or galley container status data. This allows a user to retrieve data associated with the container related to any of these parameters.

In another embodiment, the input data further comprises stock data on galley container contents, and wherein receiving the first output data on the second user interface device comprises the itemization of contents of the galley container. Additionally or alternatively, the input data further comprises data on the state of the galley container, and wherein receiving the first output data on the second user interface comprises the status of the galley container. A user may thus check a status of the container and/or whether the required items have in fact been loaded in the container.

### BRIEF DESCRIPTION OF DRAWINGS

Embodiments will now be described, by way of example only, with reference to the accompanying schematic drawings in which corresponding reference symbols indicate corresponding parts. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g. “20”) to generally refer to every instance of the element, while the element label will include an appended letter (e.g. “20a”) to refer to a specific instance of the element.

FIG. 1 schematically shows an exemplary system according to an embodiment of the invention.

FIG. 2 schematically shows a flowchart of an exemplary method according to an embodiment of the invention.

The figures are meant for illustrative purposes only, and do not serve as restriction of the scope or the protection as laid down by the claims.

### DESCRIPTION OF EMBODIMENTS

The following is a description of certain embodiments of the invention, given by way of example only and with reference to the figures.

### Embodiment 1

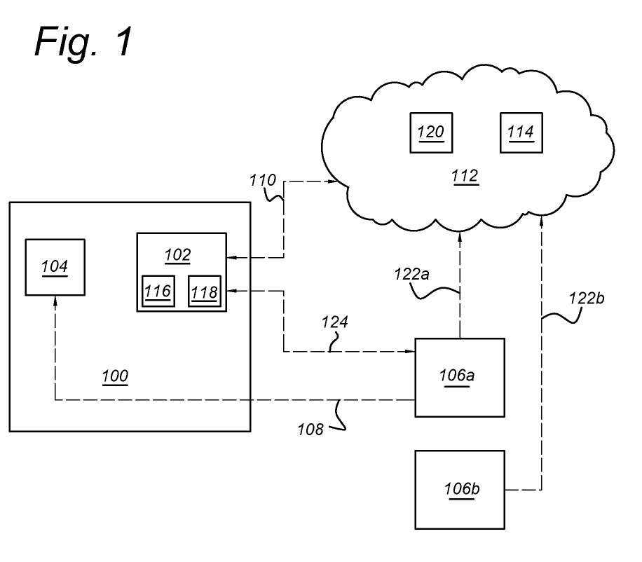

FIG. 1 schematically shows a system according to an embodiment of the invention. A galley container 100 comprises a sensor module 102 and a galley container identifier module 104. At the start of an exemplary process, the galley container 100 may be at a catering facility as the container is being prepared for a use or service cycle, for example, a flight service. At this stage, for example, a custodial status parameter may accordingly indicate that the container is presently in the custody of the catering service.

The term ‘use cycle’ or ‘service cycle’ as used herein refers to a time period or defined event involving use of the container, or any other manner of advantageously modulating any particular cycle or sub-cycle of use or being in service of the container. If the container 100 has not been previously registered in the system, an operator (user) may register the container in the system before or after preparation of the container for the use cycle. It is noted that, as with any action that may be executed with the system, authorization to register (and de-register) a container 100 may be restricted to certain entities or users of the system, as determined by the entity's or user's access/authority level.

In order to register a container 100 the operator may use the UID 106a to establish a communication link 108 between the container identifier module 104 and obtain the container identifier data. This is followed by sending input data which contains a container registration command and the container identifier data for identifying the container to be registered via the UID 106a to the server 112. The server is provided with a processor 114 and a memory unit 120. Alternatively, the container identifier data may be ‘manually’ provided to the UID by, for example, typing on a keyboard or touchscreen provided on the UID. In response, the processor 114 of the server 112 registers the container thereby generating a container profile in the database stored in the memory unit 120. The registration input data may additionally comprise fleet identifier data to enable the system to associate the container with one or more fleets during registration.

The catering operator may proceed to prepare a container 100 for a flight service by loading the container with items according to a list of contents (the list may comprise, for example, an order provided by another user, such as an airline). Additionally, the operator may perform other container preparation actions such as checking a container temperature after loading if, for example, regulations require that the container be kept below a minimum temperature because it holds perishable items for consumption (e.g. food & beverages).

After loading the container, the operator may use the first user interface device (UID) 106a to manually enter a list of contents which have been loaded to the container into a memory unit of the UID, by establishing a communication link 122a with the server 112. The data are forwarded to the server 112, via the UID, along with a command to update the container profile accordingly. Additionally, an update to the container may trigger an update to a fleet profile.

The system is now updated and other entities may access the container profile to check a status of the container. For example, a user with a second UID 106b is able to check whether the required contents have been loaded into the container via communication link 122b with the server. Alternatively, some or all of the items loaded into the container may comprise identifying means, such as RFID tags, and the container or UID 106a may be equipped with means such as an RFID tag reader to detect the presence of an item via the identifying means. This enables the automatic input of a list of contents into the UID 106a and/or to the server 112. This can particularly be useful for securely handling and tracking luxury goods loaded in the container.

According to the exemplary embodiment, the sensor module 102 comprises a temperature sensor 116 and a door sensor 118 and is configured to sense and store temperature data and security data. The sensor module according to this example is able to send parameter data to the server 112 by means of communication link 110, and/or to send parameter data to the UID by means of communication link 124. Thus, the container profile in this embodiment comprises a combination of the sensed parameter data (temperature data and security data) and manually entered data (such as the content list or the custodial data). The custodial data parameter may show the present custodial status of the container as well as time stamps related to a custodial change, for example, from a caterer operator to an airline crew operator, and vice versa.

The UID may comprise, for example, a handheld electronic device configured for the input, processing, communication, and display of data, and may comprise any number of preprogrammed applications or utilities comprising instructions for enabling the execution of a variety of tasks, such as container registration, update requests, container profile display, entity/user registration, and container identification application.

Additionally, the containers which have been registered may be marked active or inactive for a particular use cycle (for example, in an operational data field of the container profile). This enables data to be generated about, for example, the frequency of use of the container, which may offer enhanced functionality for an operator wishing to balance rotation of the containers, thus preventing, for example, excessive and undesirable usage of the container and providing greater predictability and uniformity in relation to maintenance and repairs of the containers.

### Embodiment 2

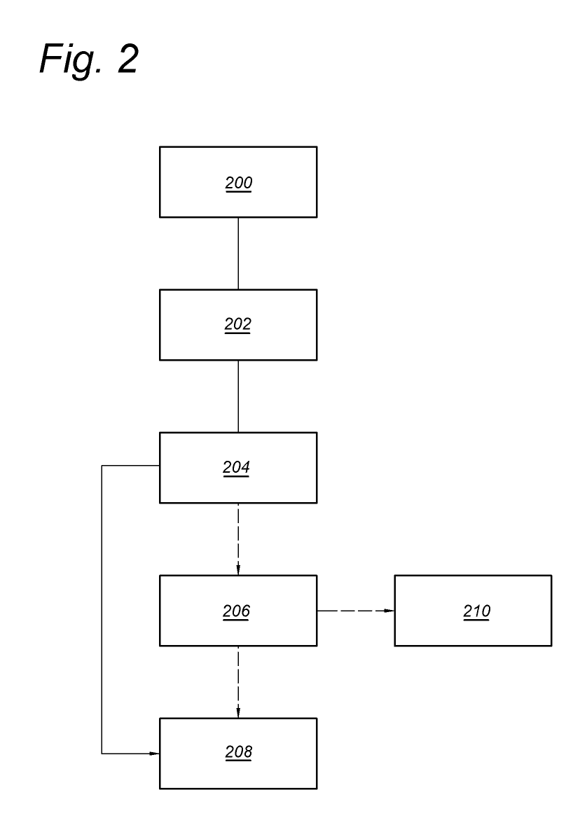

An exemplary embodiment of methods according to the invention is shown in FIG. 2 (also referring to exemplary elements in FIG. 1). According to the method the user operates a UID in order to obtain data related to a container 100, such as a part of the container profile.

The user first obtains the container identifier data in step 200 by allowing the UID to detect the container identifier data in the container identifier module. This may be effected by, for example, motioning the UID 106a towards the vicinity of the container identifier module 104 so that the UID is within a detection range of said identifier module. The detection range will depend on the identifier technology being used. The user then requests in step 202, via the UID, to view or obtain data related to the identified container. In step 204 a server 112 receives the input data sent by the user (which includes the container identifier data and a data request command), and responds by transmitting the requested output data to the UID in step 208 (for example, to second UID 106b). The UID may, for example, graphically render the output data so that the user may readily view the data.

Additionally, the server may carry out a step 206 in which the server checks an entity or user access or authority level prior to rendering output data. The entity or user access or authority level may be stored in the server database and/or in a memory unit of the UID. If the entity or user does not have the appropriate access level, the container data request is rejected and this is reported to the user via the UID in step 210. If the entity or user has the appropriate access level, the container data request is granted and the server transmits the requested output data of step 208. This feature enhances system security and scalability.

### LIST OF REFERENCE SYMBOLS

Similar reference numbers that have been used in the description to indicate similar elements have been omitted from the list below, but should be considered implicitly included.
100 container
102 sensor module
104 container identifier module
106a,b user interface device (UID)
108 communication link between UID and sensor module
110 communication link between container or sensor module and server
112 server
114 server database
116 temperature sensor
118 door sensor
120 memory unit
122a,b communication link between UID and server
124 communication link between UID and container or sensor module

1. A method for operating a galley container fleet management system by using a server, the fleet comprising one or more galley containers, the server comprising a processor and a memory unit, wherein the processor is connected to the memory unit and wherein the processor is configured to execute the following steps:
registering at least one galley container of the fleet in a database stored in the memory unit, wherein the step of registering the at least one galley container comprises associating the galley container to the galley container fleet and generating a galley container profile for associating galley container parameter data with, and, the galley container profile comprising galley container identifier data;
receiving first input data from a first user interface device, the first input data comprising at least galley container identifier data; and
rendering first output data to a second user interface device in response to the first input data; or
updating the galley container profile in response to the first input data if the first input data comprises galley container parameter data.

2. The method according to claim 1, wherein the step of updating the galley container profile comprises at least comparing the galley container profile with the first input data for determining whether and update of the galley container profile is required.

3. The method according to claim 1, wherein the step of updating the galley container profile comprises at least one of adding galley container parameter data from the first input data to the galley container profile and replacing galley container parameter data in the galley container profile with galley container parameter data from the first input data.

4. The method according to claim 1, wherein the galley container parameter data further comprises at least one of contents data, security data, location data, temperature data, custodial data, condition data and operational status data.

5. The method according to claim 1, wherein the output data related to a galley container comprises the galley container profile or a part of the galley container profile.

6. The method according to claim 1, wherein the first input data comprises a query from a querying entity and wherein the method further comprises the step of rejecting or granting the query based on the galley container profile prior to rendering output data relating to the galley container comprises, wherein rejection or grant of the query is based on an access level of the querying entity.

7. The method according to claim 1, wherein the output data related to the galley container comprises at least one of contents data, security data, location data, temperature data, custodial data, condition data and operational status data.

8. (canceled)

9. The method according to claim 1, further comprising registering at least one galley container fleet in the database, wherein the step of registering the at least one galley container fleet comprises generating a galley container fleet profile for associating at least one of a galley container fleet parameter data and galley container fleet metadata with; and
further comprising associating the galley container fleet with a data generating program.

10. (canceled)

11. The method according to claim 1, wherein the first input data further comprises a command, wherein the method further comprises after receiving the first input data from a first user interface device, executing the command; and
wherein the command comprises instructions for updating the galley container profile, and executing the command comprises updating the galley container profile according to the command instructions.

12. (canceled)

13. The method according to claim 1, wherein the first user interface device and the second user interface device comprise the same user interface device.

14. The method according to claim 1, wherein the method further comprises at least one of the step of generating an entity profile and user profile in the database; and
further comprising the step of assigning an access/authority level to the entity profile and/or user profile.

15. (canceled)

16. (canceled)

17. A management system for managing at least one galley container fleet comprising at least one galley container, the system comprising:
a server comprising a processor and a memory unit, wherein the processor is connected to the memory unit;
at least one galley container;
a galley container identifier module comprising galley container identifier data;
wherein the server is arranged to receive first input data comprising the galley container identifier data, and to render at least part of the container profile in response to said input data; and
at least one user interface device.

18. The system according to claim 17, the at least one galley container comprises at least one galley container parameter sensor module, wherein the parameter sensor module is configured to sense and record galley container parameter data; and
wherein the galley container is provided with communication means in data connection with the parameter sensor module, wherein the communication means is configured to transmit sensed parameters of the galley container from the parameter sensor module to the server.

19. (canceled)

20. The system according to claim 17, wherein the server is further arranged to update a galley container profile stored in the memory unit according to the update program in response to the first input data comprising galley container parameter data.

21. (canceled)

22. A galley container for use in the method of claim 1.

23. The galley container according to claim 22, further comprising a parameter sensor module configured to sense and store data related to one or more parameters of the galley container; and
wherein the one or more parameters comprise at least one of a temperature parameter, contents parameter, a security parameter, a cycle status parameter, a location parameter, a geographical location-related parameter, and a custody parameter.

24. (canceled)

25. The galley container according to claim 22, comprising communication means connected to the parameter sensor module, wherein the communication means is configured to transmit sensed parameters of the galley container to a server.

26. (canceled)

27. (canceled)

28. A use of the management system according to claim 17, comprising:
identifying at least one galley container of a fleet using the galley container identifier module;
with a first user interface device sending first input data comprising at least the galley container identifier data, to the server, wherein the first input data is compared with a galley container profile;
receiving first output data on a second user interface device in response to the first input data.

29. The use according to claim 28, wherein the first input data further comprises galley container parameter data, comprising at least one of an itemization of contents of the galley container, security-related history of the galley container, a galley container location history, a galley container geographical location history, a galley container temperature history, and a status of the galley container; and
wherein the input data comprises access level data, wherein sending the input data comprises sending a query to the server and wherein receiving first output data comprises a rejection or a grant of the query based on the access level data.

30. The use according to claim 28, wherein the output data related to a galley container comprises the galley container profile or a part of the galley container profile; and
wherein the output data related to the galley container comprises data related to at least one of a contents of the galley container, galley container security data, a galley container location data, a galley container temperature data, galley container custodial data, and a galley container operational status data.

31. (canceled)

32. (canceled)
